(19) United States
(12) Patent Application Publication
(10) Pub. No.: US 2014/0241789 A1
(43) Pub. Date: Aug. 28, 2014

(54) LOCKING DEVICE FOR AN EXTENDIBLE TUBE ASSEMBLY

(71) Applicant: E DAN INDUSTRIAL CO., LTD, New Taipei City (TW)

(72) Inventor: Tse-Lien Chiu, New Taipei City (TW)

(73) Assignee: E DAN INDUSTRIAL CO., LTD, New Taipei City (TW)

(21) Appl. No.: 13/781,678

(22) Filed: Feb. 28, 2013

(51) Int. Cl. F16B 7/10

(52) U.S. Cl. CPC F16B 7/10
USPC 403/109.1

(57) ABSTRACT

A locking device for an extendible tube assembly has: an extendible tube, an enforced locking block and a controlling member. The extendible tube includes an inner tube and an outer tube, an end of the outer tube having a through hole on a pivoting base. The enforced locking block has a first end and a second end, the second end includes an indented portion that provides a resting edge; the second end of the enforced locking block is inserted in the through hole of the outer tube such that the resting edge of the second end makes contact with the inner tube in the outer tube. A pivoting portion of the controlling member is provided with an eccentric block, another end of the controlling member is provided with a handle; the pivoting portion of the controlling member is pivoted onto the pivoting base of the extendible tube.

### BACKGROUND OF THE INVENTION

1. Field of the Invention

The present invention relates to a locking device for an extendible tube assembly, and more particularly to locking device for an extendible tube assembly for tables and chairs.

2. Description of the Related Art

Comfortable tables and chairs are essential for study and working, but most of tables and chairs have fixed heights which are suitable for users with various body heights. Especially for children and teenagers, tables and chairs with adjustable heights are necessary. Therefore, an extendible support structure for tables and chairs is developed.

However, a typical extendible support structure utilizes a single point contact between two supporting rods, which does not provide enough supports and safety. Furthermore, an extended member often is not positioned correctly, which causes users need to adjust it repeatedly.

Therefore, it is desirable to provide a locking device for an extendible tube assembly to mitigate and/or obviate the aforementioned problems.

### SUMMARY OF THE INVENTION

An objective of the present invention is to provide a locking device for an extendible tube assembly, which provides more steady support. In order to achieve the above mentioned objective, a locking device for an extendible tube assembly comprises: an extendible tube, an enforced locking block and a controlling member. The extendible tube includes an inner tube and an outer tube, the inner tube capable of sliding along the outer tube, an end of the outer tube has a through hole on a pivoting base. The enforced locking block has a first end and a second end, the second end includes an indented portion that provides a resting edge. The second end of the enforced locking block is inserted in the through hole of the outer tube such that the resting edge of the second end makes contact with the inner tube in the outer tube. A pivoting portion of the controlling member is provided with an eccentric block, another end of the controlling member is provided with a handle; the pivoting portion of the controlling member is pivoted onto the pivoting base of the extendible tube, such that the handle controls the eccentric block to push against the enforced locking block and the resting edge engages with the inner tube.

Other objects, advantages, and novel features of the invention will become more apparent from the following detailed description when taken in conjunction with the accompanying drawings.

### BRIEF DESCRIPTION OF THE DRAWINGS

FIG. 1 is a perspective assembly drawing of a preferred embodiment of the present invention.

FIG. 2 is an exploded drawing of the preferred embodiment of the present invention.

FIG. 3 is a local detail drawing of the preferred embodiment of the present invention.

FIG. 4 is a cross-sectional drawing of the preferred embodiment of the present invention.

FIG. 5 is another cross-sectional drawing of the preferred embodiment of the present invention.

FIG. 6 is a schematic drawing of the preferred embodiment of the present invention.

### DETAILED DESCRIPTION OF THE PREFERRED EMBODIMENT

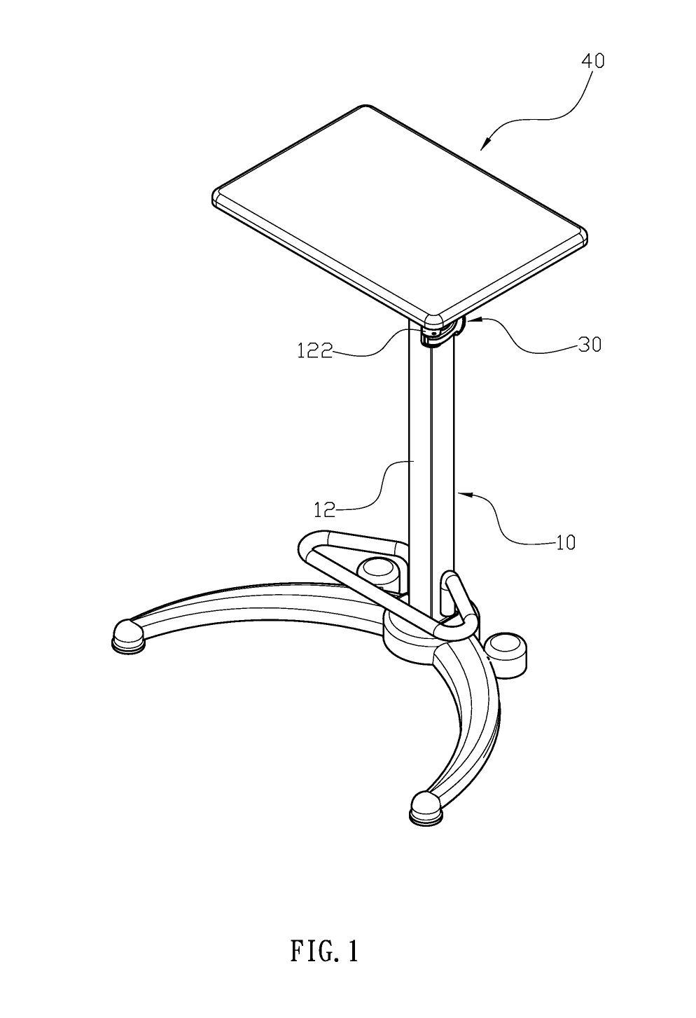

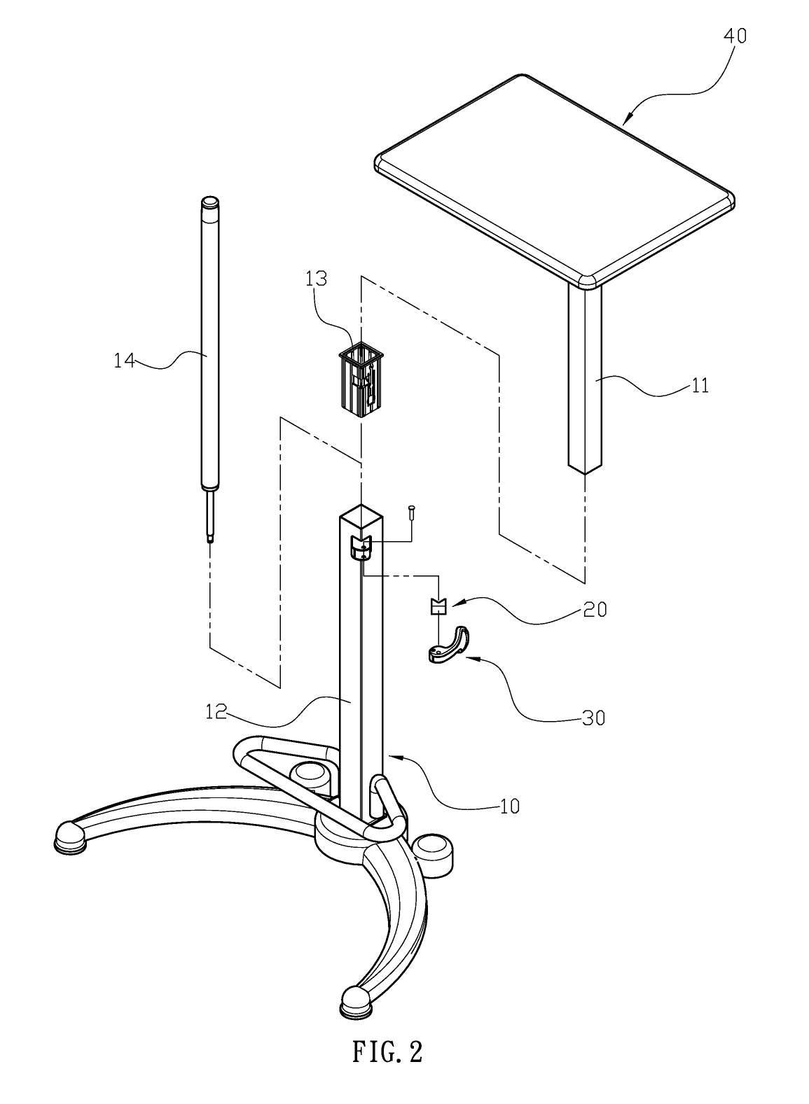

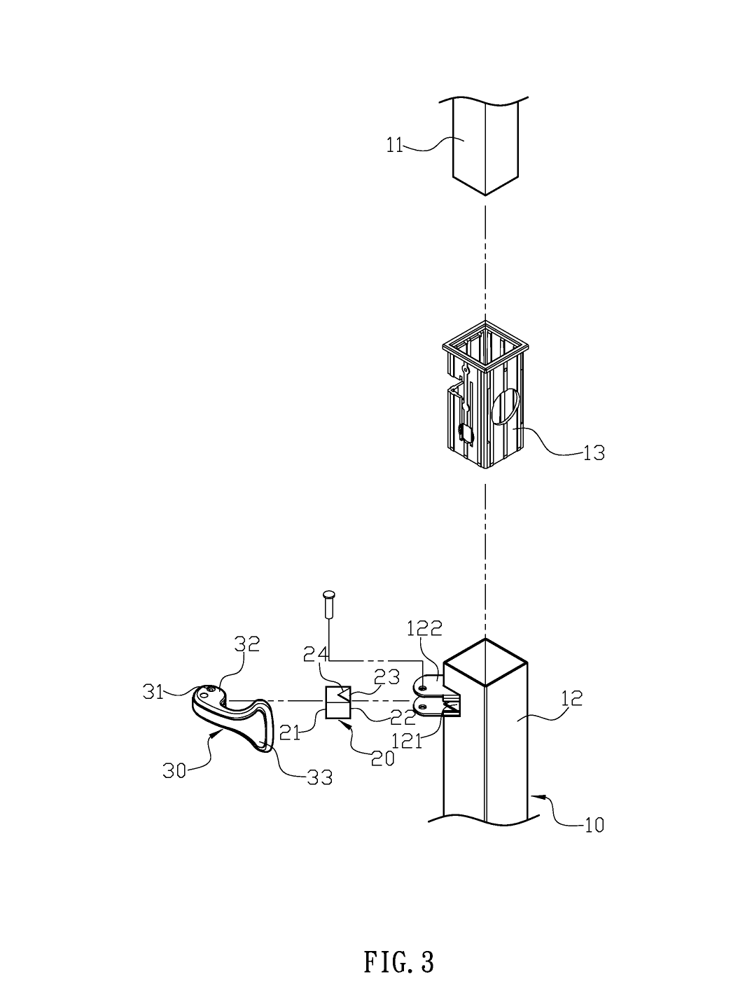

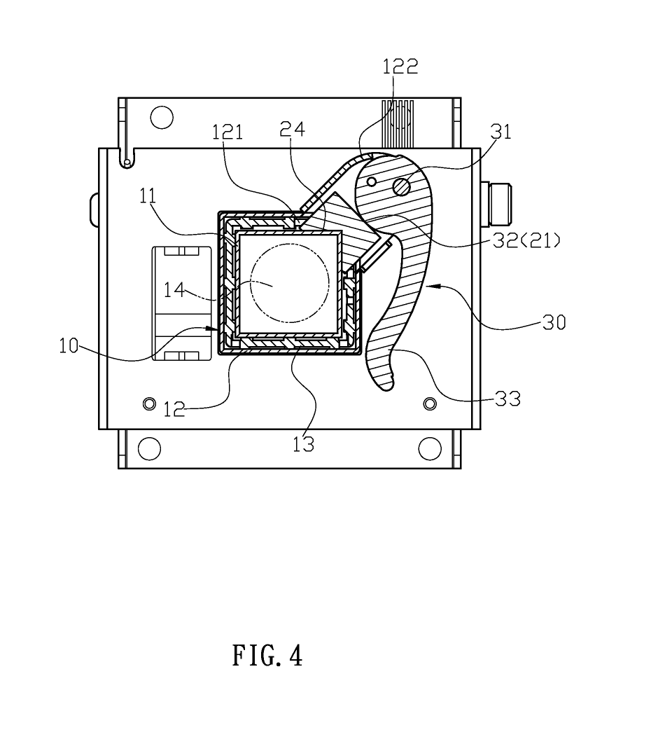

Please refer to FIG. 1 to FIG. 4. A locking device for an extendible tube assembly comprises: an extendible tube 10, an enforced locking block 20 and a controlling member 30. The extendible tube 10 includes an inner tube 11 and an outer tube 12, and the inner tube 11 is capable of sliding along the outer tube 12. A sleeve 13 is attached onto an upper portion of the outer tube 12, the sleeve fills in a gap between the inner and outer tubes 11, 12 to prevent vibration of the inner tube 11. The inner tube 11 and the outer tube 12 have corresponding shapes such as rectangular or circular. Furthermore, the inner tube 11 is provided with an internal extendable control rod 14, and the extendable control rod 14 is a hydraulic cylinder, a gas cylinder or an elastic member with a fixed lower end. An end of the outer tube 12 has a through hole 121 on a pivoting base 122. When the outer tube 12 has a rectangular shape, the through hole 121 is disposed at one of the outer tube 12. The enforced locking block 20 has a first end 21 and a second end 22. The second end 22 includes an indented portion 23 that provides a resting edge 24. The second end of 22 the enforced locking block 20 is inserted in the through hole 121 of the outer tube 12 such that the resting edge 24 of the second end 22 makes contact with the inner tube 11 in the outer tube 12. A pivoting portion 31 of the controlling member 30 is provided with an eccentric block 32, another end of the controlling member 30 is provided with a handle 33. The pivoting portion 31 of the controlling member 30 is pivoted onto the pivoting base 122 of the extendible tube 10, such that the handle 33 is capable of controlling the eccentric block 32 to push against the enforced locking block 20 and the resting edge 24 engages with the inner tube 11.

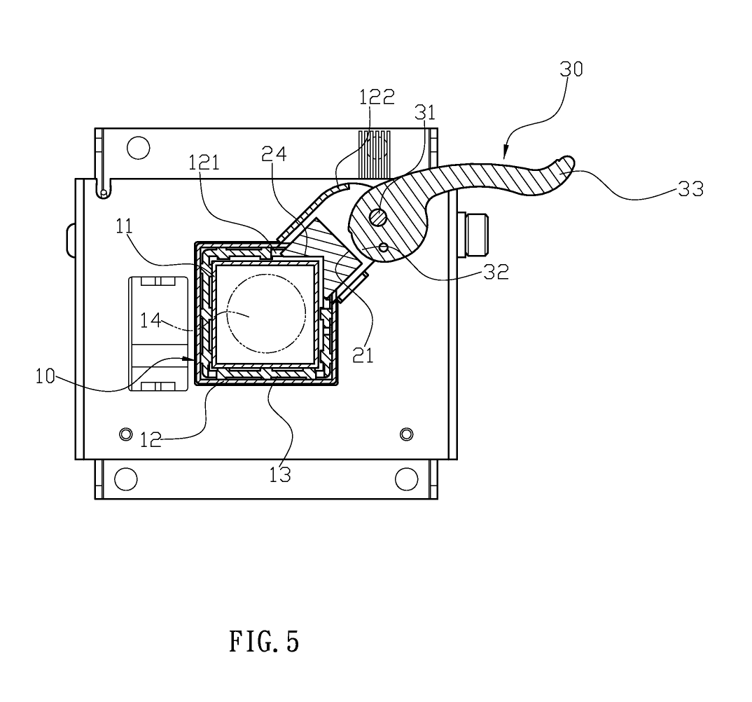

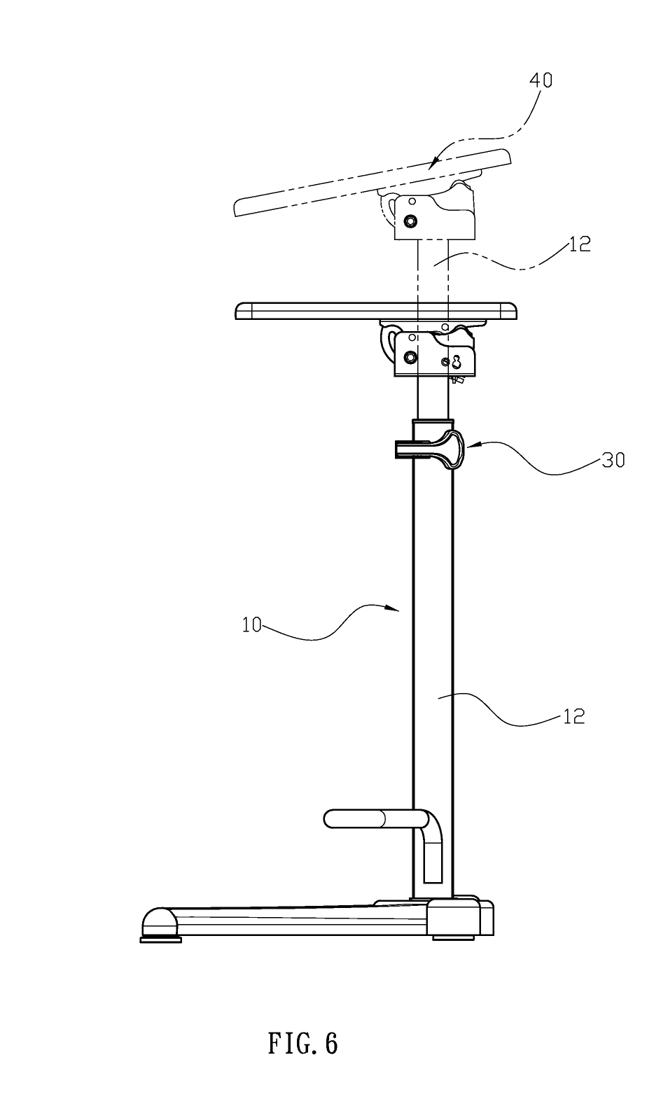

For actual operation, when the handle 33 is pushed downwardly, the eccentric block 32 pushes the enforced locking block 20 inwardly, the resting edge 24 engages with the inner tube 11 to securely position the inner tube 11. Therefore, the inner tube 11 is free from accidently dropping, which provides better safety and convenience. Please refer to FIG. 5 and FIG. 6 together, in order to adjust the height, the handle 33 of the controlling member 30 is lifted upwardly to move the eccentric block 32 away from the first end 21 of the enforced locking block 20, such that the inner tube 11 is not limited by the resting edge 24. Then, the handle 33 of the controlling member 30 is pushed down again to secure.

Moreover, the extendible tube 10 is suitable to be mounted onto a chair, to provide support to a seat portion and a back portion, or onto a table, to provide support for a table top 40, or onto a table having an adjustable table top.

Although the present invention has been explained in relation to its preferred embodiment, it is to be understood that many other possible modifications and variations can be made without departing from the spirit and scope of the invention as hereinafter claimed.

What is claimed is:

1. A locking device for an extendible tube assembly comprising: an extendible tube, an enforced locking block and a controlling member, wherein:
the extendible tube includes an inner tube and an outer tube, the inner tube capable of sliding along the outer tube, an end of the outer tube having a through hole on a pivoting base;
the enforced locking block has a first end and a second end, the second end including an indented portion that provides a resting edge; the second end of the enforced locking block is inserted in the through hole of the outer tube such that the resting edge of the second end makes contact with the inner tube in the outer tube; and
a pivoting portion of the controlling member is provided with an eccentric block, another end of the controlling member provided with a handle; the pivoting portion of the controlling member is pivoted onto the pivoting base of the extendible tube, such that the handle controls the eccentric block to push against the enforced locking block and the resting edge engages with the inner tube.

2. The locking device for an extendible tube assembly as claimed in claim 1, wherein a sleeve is attached onto an upper portion of the outer tube, the sleeve filling a gap between the inner and outer tubes to prevent vibration of the inner tube.

3. The locking device for an extendible tube assembly as claimed in claim 1, wherein the inner tube and the outer tube respectively have identical rectangular shapes, and the through hole is disposed at one corner of the outer tube.

4. The locking device for an extendible tube assembly as claimed in claim 1, wherein the inner tube and the outer tube respectively have identical circular shapes.

5. The locking device for an extendible tube assembly as claimed in claim 1, wherein the inner tube is provided with an internal extendable control rod, and the extendable control rod is a hydraulic cylinder, a gas cylinder or an elastic member with a fixed lower end.

6. The locking device for an extendible tube assembly as claimed in claim 1, wherein the extendible tube is mounted onto a table, to provide support for a table top.

7. The locking device for an extendible tube assembly as claimed in claim 1, wherein the extendible tube is mounted onto a table having an adjustable table top.

8. The locking device for an extendible tube assembly as claimed in claim 1, wherein the extendible tube is mounted onto a chair, to provide support to a seat portion and a back portion.
